(19) United States
(12) Patent Application Publication
(10) Pub. No.: US 2009/0049897 A1
(43) Pub. Date: Feb. 26, 2009

(54) METHOD FOR ON-LINE ADAPTATION OF ENGINE VOLUMETRIC EFFICIENCY USING A MASS AIR FLOW SENSOR

(76) Inventors: Peter M. Olin, Ann Arbor, MI (US); Sergio Quelhas, Ann Arbor, MI (US); Koon Chul Yang, Pittsford, NY (US); Sergio E. Garcia, Webster, NY (US)

Correspondence Address: DELPHI TECHNOLOGIES, INC., M/C 480-410-202, PO BOX 5052, TROY, MI, 48007, US

(21) Appl. No.: 11/844,781

(22) Filed: Aug. 24, 2007

(51) Int. Cl. G01L 3/26; G01M 15/04

(52) U.S. Cl. 73/114.32; 73/114.01

(57) ABSTRACT

An electronic engine controller is configured to execute a process of adapting a base value of the volumetric efficiency of an engine through the addition of a correction value of the volumetric efficiency. The process includes comparing an estimated mass air flow value calculated using a speed-density equation, with an actual mass air flow value measured by a mass air flow (MAF) sensor. A percentage error of the estimated mass air flow value as compared to the actual mass air flow value is calculated. When the percentage error indicates that the air flow is at steady state, then the process updates the VE correction value, by integrating the percentage error. The new correction value, thus computed, is then stored in a cell of an array corresponding to the current engine operating condition. The process is configured to add the correction value to the corresponding base value to produce an updated value of the VE, valid for that operating condition. The process accommodates changes in the volumetric efficiency of the engine due to part aging and deposit build-up over time, among other things. The updated VE value may then be used for mass air flow estimation and accordingly for fueling control as well.

### TECHNICAL FIELD

The present invention relates to a method for on-line adaptation of engine volumetric efficiency using a mass air flow sensor.

### BACKGROUND OF THE INVENTION

Accurate control of engine air/fuel ratio requires knowledge of the mass air flow entering the engine cylinders in each combustion cycle. Ordinarily, this can be relatively accurately determined through a speed-density calculation based on the measured engine speed and intake manifold temperature and absolute pressure, taking into account various factors including the volumetric efficiency (VE) of the engine, as seen by reference to U.S. Pat. No. 6,393,903 entitled VOLUMETRIC EFFICIENCY COMPENSATION FOR DUAL INDEPENDENT CONTINUOUSLY VARIABLE CAM PHASING to Reed et al., assigned to the common assignee of the present invention, and incorporated herein by reference in its entirety. The volumetric efficiency of an engine in turn may be calibrated on a small number of prototype engines during development. This calibration is then generally used across an entire production run of that engine. The VE value is an important part of estimating the mass air flow entering into the engine cylinders, which is important for accurate fueling control.

The volumetric efficiency of an engine is dependent on the mechanical geometry of the engine. Many factors can lead to errors in the application of a single volumetric efficiency calibration to an entire production run of an engine, including part-to-part variation in the manufacture of the engine, part aging (e.g., of the engine components) and deposits accumulating in the flow path. When the engine is running, the volumetric efficiency is generally calculated based on engine sensor readings. Part-to-part variation and part aging of those sensors can also lead to an incorrect value for the volumetric efficiency being used for calculating mass air flow. Errors in volumetric efficiency can therefore lead to fueling errors and/or torque control errors.

The algorithms (i.e., software) of an engine management system (EMS) include logic to make the overall system more robust to errors in the system, such as those described above (e.g., part-to-part variation, aging, faults and the like). For example, it is known to adjust fueling based on exhaust gas oxygen (O₂) sensor feedback, employ throttle flow calibration learning based on MAF sensor response, and employ air flow calibration learning based on MAP sensor response. Thus, it is known generally in the art to employ methodologies that make the system robust to the volumetric efficiency errors described above.

There can, however, be many sources of variation or errors in the system, not just those pertaining to volumetric efficiency. For example, fuel injector variation and throttle body variation can impact fueling accuracy. It is therefore important to minimize, where possible, the sources of error that can occur so as to minimize the amount of work required by the robustness logic. The more active the robustness logic, the greater the likelihood that the system will be operating away from its optimal performance. For example, variations can sometimes be additive and in other cases cancel each other out.

In some configurations, a mass air flow (MAF) sensor is used to measure the mass air flow directly in order to make the system more robust to the issues described above as affecting the determination of volumetric efficiency (and so also the air flow). A MAF sensor, however, can only be used as a measure of air flow into the engine under steady-state flow conditions, since it must generally be located far up-stream of the flow into the engine cylinders. For that reason, some method of determining air flow into the engine cylinders, under transient flow conditions, must be implemented. A conventional method for doing this involves estimating by way of calculation the transient mass air flow into the engine cylinders using the speed-density equation mentioned above, one part of which is a calculation of the volumetric efficiency. Thus, even on applications with a MAF sensor, there can be a volumetric efficiency model (i.e., for transient flow conditions) that must be calibrated, and which faces the error sources described above.

There is therefore a need for a system and method for providing an accurate calculation of volumetric efficiency under a broad range of conditions that minimizes or eliminates one or more of the problems described above.

### SUMMARY OF THE INVENTION

The present invention is directed to a method of using a mass air flow (MAF) sensor output signal to adapt a base value (i.e., a calibration based value) of the volumetric efficiency (VE) for a production engine so that such base value can be adjusted, using a correction value, to an accurate final value for that engine. The invention simplifies the initial calibration process, as well as improves the crank-to-run air flow calculation (and thus also the fueling accuracy) and the transient air flow calculation (and thus also the fueling accuracy).

A method for determining an accurate value of the volumetric efficiency of an internal combustion engine includes a number of steps. The first step involves determining an estimated mass air flow value based on the current VE calibration. The next step involves measuring an actual mass air flow value (e.g., using a MAF sensor). The next step involves determining a percentage error of the estimated mass air flow value as compared to the actual mass air flow value. Next, generating a correction value of the volumetric efficiency when the percentage error satisfies predetermined criteria indicative of a steady state air flow. The final step involves producing an updated value of the volumetric efficiency using a base value and the correction value determined above. In a preferred embodiment, the correction value is simply added to the base value to get the final, accurate value for VE.

The invention takes into account VE errors arising from part aging, accumulation of deposits, etc. when it calculates the correction value. When the correction value is added to the base value, the errors arising from such sources is reduced or eliminated.

Other features, aspects and advantages of the present invention are also presented.

### BRIEF DESCRIPTION OF THE DRAWINGS

The present invention will now be described, by way of example, with reference to the accompanying drawings.

FIG. 1 is a schematic diagram of a system that may be used to implement the method of the present invention, showing an electronic engine controller responsive to a MAF sensor output signal that is configured to generate an on-line adapted VE value.

FIG. 2 is a flowchart diagram showing the inventive VE learning logic methodology, placed in the context with existing functions in the system of FIG. 1.

FIG. 3 is a flowchart diagram showing, in greater detail, the inventive VE learning logic shown in block form in FIG. 2.

### DETAILED DESCRIPTION OF THE PREFERRED EMBODIMENT

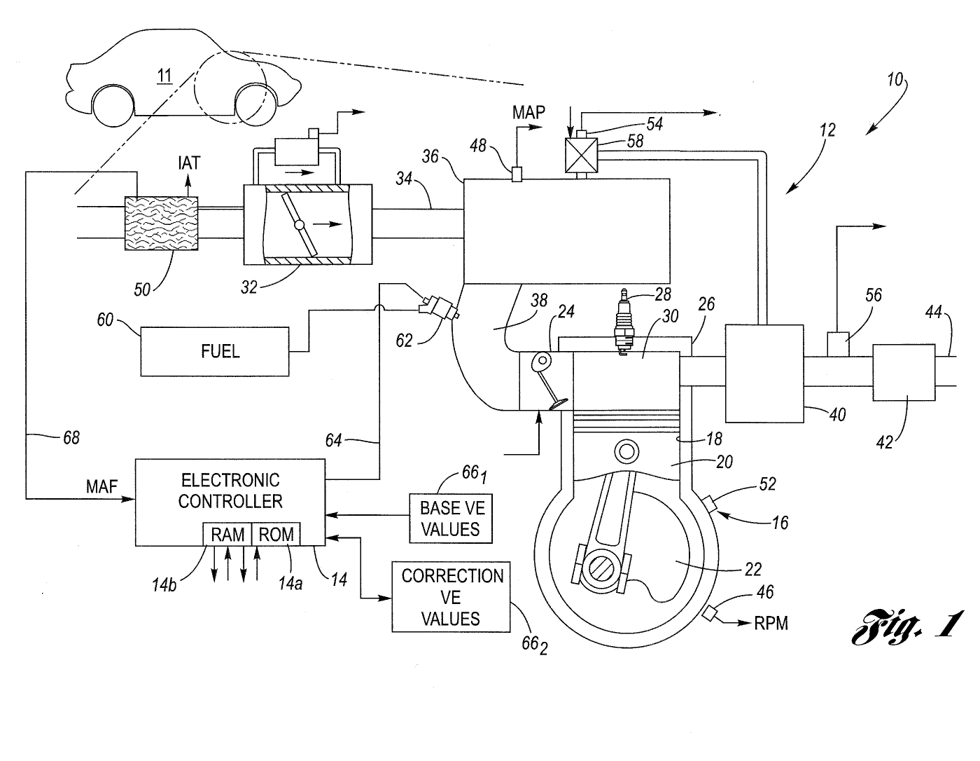

Referring now to the drawings, wherein the Figures are for the purpose of illustrating an embodiment of the invention only, FIG. 1 shows an internal combustion engine system 10 in an automotive vehicle 11. The system 10 includes an internal combustion engine 12 controlled by an electronic engine controller 14, all in accordance with the present invention. Engine 12 may be a spark-ignition engine that includes a number of base engine components, sensing devices, output systems and devices, and a control system.

Electronic controller 14 is configured via suitable programming to contain various software algorithms and calibrations, electrically connected and responsive to a plurality of engine and vehicle sensors, and operably connected to a plurality of output devices. Controller 14 includes at least one microprocessor, associated memory devices such as read only memory (ROM) 14a and random access memory (RAM) 14b, input devices for monitoring input from external analog and digital devices, and output drivers for controlling output devices. In general, controller 14 is operable to monitor engine operating conditions and operator inputs using the plurality of sensors, and control engine operations with the plurality of output systems and actuators, using pre-established algorithms and calibrations that integrate information from monitored conditions and inputs. The software algorithms and calibrations which are executed in electronic controller 14 may generally comprise conventional strategies known to those of ordinary skill in the art. These programmed algorithms and calibrations are configured, when executed, to monitor the engine operating conditions and operator demands using the plurality of sensors, and control the plurality of engine actuators accordingly. The software algorithms and calibrations are preferably embodied in pre-programmed data stored for use by controller 14.

While a more detailed description of the various components shown in FIG. 1 will be set forth below, for purposes of the present invention, the most immediately applicable aspects of system 10 will be described first. In this regard, engine 12 may include a fuel delivery control system including a source of liquid fuel 60, a plurality of fuel injectors, one being shown as fuel injector 62 that is responsive to a fuel injection control signal 64 produced by controller 14. The fuel delivery control system is generally configured to deliver a requisite mass of fuel to the engine to meet operator demands while also ensuring the engine meets the requisite emissions requirements. Engine controller 14 is configured to determine a mass amount of fuel to deliver to a cylinder, based upon engine operating conditions and operator demands. As described in the Background, controller 14 must determine an accurate value of the mass air flow moving into the engine cylinders. With this and other information, controller 14 is then in a position to calculate an amount of time, or pulse width, the corresponding fuel injector must be controlled open to deliver the mass amount of fuel to the cylinder, based upon the calibration for a particular fuel type, and other available information. Controller 14 actuates the injector solenoid for the calculated pulse width to deliver the appropriate mass amount of fuel.

FIG. 1 also shows that controller 14 is coupled to a pair of data structures: a first data structure, designated 661, is configured to store a plurality of base values of the engine volumetric efficiency, and a second data structure, designated 662, is configured to store a plurality of correction values of the engine volumetric efficiency. Data structures 66, and 662 are organized as arrays where each base value (or correction value, as the case may be) is associated with an engine operating condition to form a data pair. It should be appreciated, however, that other arrangements may be employed, consistent with the teachings of the present invention. As will be described in greater detail below, data from both arrays 66, and 662 are retrieved by controller 14 during run time (e.g., while engine 10 is running) to compute an updated value of the engine VE. One embodiment contemplates that VE base values will remain, generally, static as per the original development and calibration for engine 12, while the VE correction values will be continuously updated during the operating life of engine 12, to reflect part aging, deposit build-up, etc., all as described above. In this regard, the base VE values in table 66, may be stored in ROM, as per the single-ended arrowhead in FIG. 1. It should be understood, however, that the table 661, may be stored in other memory types and remain within the spirit and scope of the present invention.

With continued reference to FIG. 1, a mass air flow (MAF) sensor 50 is provided for generating an output signal 68 indicative of the actual mass air flow into the engine. Note, MAF sensor 50 is located fairly upstream of the intake valve(s) 24, and as described in the Background, is suitable for measuring steady state air flows into the engine.

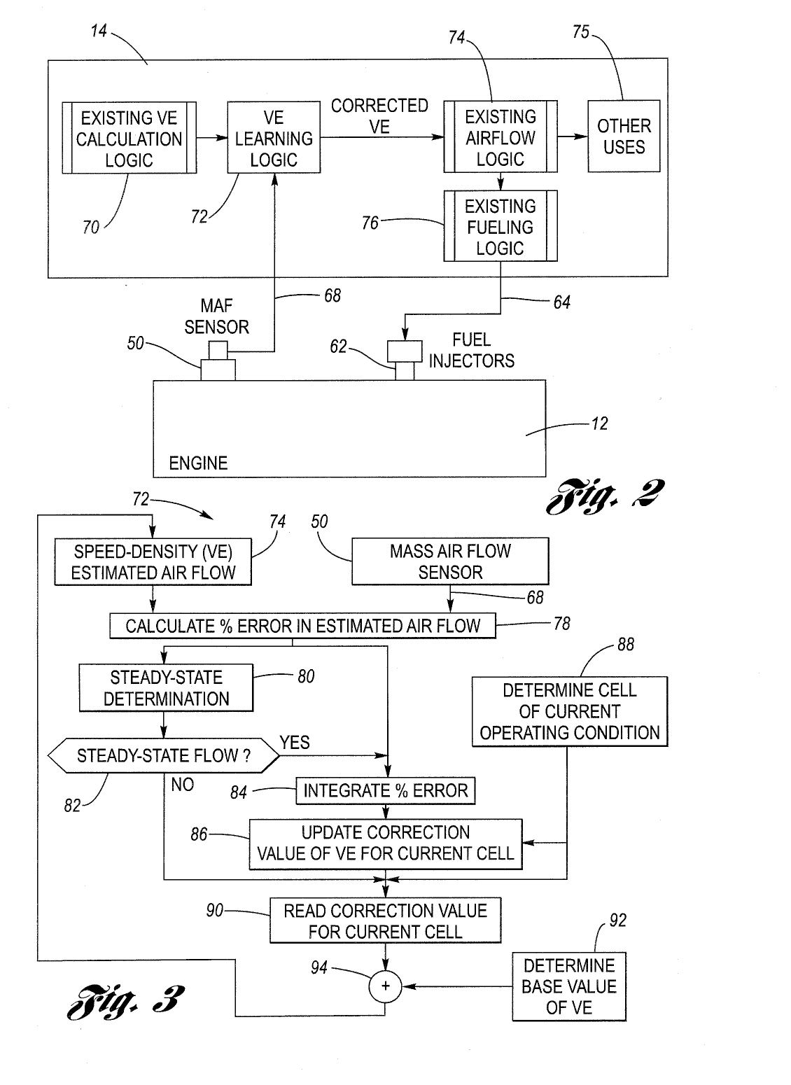

FIG. 2 is a combined flow chart and block diagram showing the inventive VE learning logic placed in context relative to existing, conventional engine fueling functionality. FIG. 2 shows volumetric efficiency (VE) calculation logic 70, the inventive VE learning logic 72, air flow determining logic 74, block 75 showing other uses of the corrected airflow calculation, and fueling logic 76. VE calculation logic 70 may comprise conventional strategies for determining an estimated value of the engine VE, for example, via a pre-production development and calibration approach as described in the Background section. Learning logic 72 is responsive to an actual, measured value of the mass air flow provided by the MAF sensor and is configured to provide an updated, accurate engine VE value to air flow logic 74. This allows a more accurate determination of mass air flow, which in turn is provided to fueling logic 76, which in turn allows the fueling logic 76 to calculate a more accurate value of the mass of fuel to be injected into the engine cylinder. Block 75 shows that while perhaps the most important use of the corrected airflow value from block 74 is for fueling, it should be understood that such value may be used by other subsystems, and therefore other uses are possible. Air flow logic 74 may be responsive to the updated engine VE value as well as other sensor outputs available in system 10. Logic 74 may comprise conventional approaches for determining mass air flow, such as a standard implementation of a speed-density calculation, for example, as described in U.S. Pat. No. 6,393,903 entitled VOLUMETRIC EFFICIENCY COMPENSATION FOR DUAL INDEPENDENT CONTINUOUSLY VARIABLE CAM PHASING to Reed et al., owned by the common assignee of the present invention, and herein incorporated by reference in its entirety. Fueling logic 76 may comprise conventional strategies as well for determining desired fuel amounts to be injected and for controlling the injection event in accordance with operating conditions and operator demand.

FIG. 3 shows, in greater detail, VE learning logic 72. The method of FIG. 3 is illustrated in the form of a continuous process with feedback. The method, beginning at the top of FIG. 3, shows air flow estimation logic 74 (Speed-Density) configured to determine an estimated mass air flow value of an air flow into the engine cylinders. FIG. 3 further shows mass air flow sensor 50, in block form, configured to measure an actual mass air flow value of the air flow into the engine cylinders and generating signal 68 indicative of the measured mass air flow. The method then proceeds to step 78.

In step 78, controller 14 is configured to determine a percentage error of the estimated mass air flow value as compared to the actual (measured) mass air flow value. The method then proceeds to step 80.

In step 80, controller 14 is configured to determine whether the percentage error satisfies predetermined criteria indicative of a steady state air flow. In one embodiment, the air flow is considered to be steady state when the percentage error changes by less than a defined amount over a defined time period. When the air flow is determined not to be at steady state, then no updating is performed. The logic then branches to step 90. However, when the air flow is determined to be at steady state, then the updating is performed and the logic branches to step 84.

In step 84, controller 14 implements the decision, made in step 80, to performing an updating operation. Controller 14 is configured to generate a new VE correction value based on the percentage error computed in step 78. The integration is carried out by adding to the current learned value a multiple of the current error, where the multiple used can be a function of, for example, current measure airflow. The method then proceeds to step 86.

In step 86, controller 14 is configured to update a cell in array 662 (best shown in FIG. 1), which holds the VE correction values. The particular cell being updated with the value just calculated in step 84 corresponds to the current operating condition, as determined in step 88. The operating conditions used to determine the current cell can be, for example, the measured throttle valve position and measured engine speed. The method proceeds to step 90.

In step 90, controller 14 resumes main line execution of its pre-programmed process for determining an engine VE value. In step 90, controller 14 is configured to read the VE correction value from the cell in array 662 that corresponds to the current operating condition. It should be understood by one of ordinary skill in the art that not every operating condition may have its own cell, and that certain strategies may involve either selecting the cell that most nearly meets the present operating condition, or alternatively, may involve interpolating between values from nearest cells.

In step 92, controller 14 is configured to determine a VE base value based on the current operating condition.

In step 94, controller 14 is configured to produce an updated value of the VE using the VE base value and the VE correction value (both for the current operating condition). As illustrated, the base value and the correction value are preferably added to obtain the updated value. The updated VE value is then used in evaluating the Speed-Density equation for arriving at an estimated mass air flow, which can be used in transient air flow situations. As described above, this more accurate VE value may be used by the fueling logic to obtain more accurate fuel calculation, particularly over the passage of time.

The present invention reduces or eliminates sources of errors in determining a value of the engine volumetric efficiency, which in turn has the favorable effect of reducing or eliminating fueling errors or torque control errors. Such sources of errors may be present even when an engine is initially manufactured, such as, for example, errors arising from part-to-part variation in the engine components. Since the method is preferably performed over the service life of the engine, such adaptive features allow for a reduction/elimination of errors arising from aging of engine components, deposits accumulating in the air flow path, and the like.

Returning now to FIG. 1, further details concerning system 10 will be set forth to more fully describe the exemplary environment for the present invention. It should be understood that portions of the following are exemplary only and not limiting in nature. Many other configurations are known to those of ordinary skill in the art and are consistent with the teachings of the present invention.

The base engine components of engine 12 include an engine block 16 with a plurality of cylinders, one of which is shown in FIG. 1 and is designated cylinder 18. Each cylinder 18 contains a respective piston 20 operably attached to a crankshaft 22 at a point eccentric to an axis of rotation of crankshaft 22. There is a head 26 at the top of each piston 20 containing one or more air intake valves 24 and associated lift/actuation mechanization, one or more exhaust valves (not shown), and a spark plug 28. A combustion chamber 30 is formed within cylinder 18 between piston 20 and the head 26. An intake manifold is fluidly connected to engine head 26, substantially adjacent air intake valves 24. The intake manifold is connected to an air control valve 32, and includes a common air inlet 34 into a plenum 36, which flows into a plurality of parallel intake runners 38. The plurality of parallel intake runners 38 is preferably formed to permit flow of substantially equal volumes of air from the air control valve 32 to each of the plurality of cylinders 18. An exhaust manifold 40 is fluidly connected to engine head 26, substantially adjacent the exhaust valves, and facilitates flow of exhaust gases away from the engine to exhaust system components 42, 44.

The system 10 includes a variety of sensors. The plurality of sensing devices of the exemplary internal combustion engine 12 are operable to measure ambient conditions, various engine conditions and performance parameters, and operator inputs. Typical sensors include a crankshaft position sensor 46 configured to generate an engine speed indicative signal, a camshaft position sensor (not shown), a manifold absolute pressure (MAP) sensor 48, one or more spark knock sensors (not shown), a throttle position sensor (not shown), a mass air flow (MAF) sensor 50, an intake air temperature (IAT) sensor (shown as an element of the mass air flow sensor 50), a coolant temperature sensor 52, an exhaust gas recirculation (EGR) position sensor 54, and one or more oxygen sensors or other exhaust gas sensors 56.

The plurality of output systems and devices of the exemplary internal combustion engine 12 are operable to control various elements of engine 12, and include an air intake system, a fuel injection system, an ignition system, an exhaust gas recirculation (EGR) valve 56 and related system, a purge control system (not shown) and exhaust system 42, 44. The air intake system is operable to deliver filtered air to the combustion chamber 30 when the intake valve(s) 24 are open. The air intake system preferably includes an air filtering system fluidly connected to air control valve 32, which is fluidly connected to the intake manifold.

FIG. 1 also shows a fuel source, designated by reference numeral 60, which feeds a set of fuel injectors 62 configured to deliver fuel to corresponding cylinders of engine 12, one of which is shown in FIG. 1. Fuel injector 62 may be placed in a corresponding intake runner 38 at an end of the runner adjacent to the engine head 26, substantially near the intake valve(s) 24 to the cylinder 18. Conventionally, fuel may be liquid fuel, but may alternatively comprise propane fuel, natural gas fuel (compressed natural gas—CNG), or other fuel types now known or hereafter developed. Design of an air intake system, including all of the aforementioned components, is known to one of ordinary skill in the art. The exemplary liquid fuel delivery and injection system comprises storage tank 60 mentioned above with a high-pressure fuel pump (not shown) that provides fuel to a fuel line and fuel rail (not shown) to deliver liquid fuel to each of the plurality of fuel injectors 62. Each fuel injector 62 is fluidly connected and operable to deliver a quantity of fuel to one of the plurality of intake runners 38. Each fuel injector 62 is controlled according to a respective fuel injection signal generated by electronic controller 14 and delivered via a respective electrical connection. Each fuel injection signal controls the open time of the associated fuel injector. Mechanization of an internal combustion engine, using sensors, output devices, and controller 14 including development of algorithms and calibrations, is known generally to those of ordinary skill in the art.

Strategies for mass air flow estimation are also known generally in the art, specifically the so-called speed-density equation. U.S. Pat. No. 6,393,903 described above disclose one approach speed-density calculation, which may be suitable for use in the present invention. The speed-density method has been used to accurately compute (estimate) a mass airflow (MAF) based on the measured engine speed (ES) and intake manifold temperature (IMAT) and absolute pressure (IMAP), and the engine volumetric efficiency VE as follows in equation (1).

MAF=(IMAP*Vd*ES *VE)/(2*R*IMAT) (1)

where Vd is the combustion chamber volume and R is a gas constant. The volumetric efficiency, defined as the ratio of the air volume ingested into the combustion chamber to the swept volume of the pistons, can be estimated based on engine speed ES and a ratio (PR) of the intake manifold pressure IMAP to the exhaust manifold absolute pressure (EMAP), as follows in equation (2):

VE=A+(B*PR) (2)

where the coefficients A and B are empirically determined functions of engine speed ES for a given cam phasing. The volumetric efficiency may simply be determined by a table-look up as a combined function of engine speed ES and pressure ratio PR. It should be understood that other strategies, known in the art, may be suitable for use in determining a VE base value of engine 12, and remain within the spirit and scope of the present invention.

Additionally, it should be understood that electronic controller 14 as described above may include conventional processing apparatus known in the art, capable of executing pre-programmed instructions stored in an associated memory, all performing in accordance with the functionality described herein. That is, it is contemplated that the processes described herein will be programmed in a preferred embodiment, with the resulting software code being stored in the associated memory. Implementation of the present invention, in software, in view of the foregoing enabling description, would require no more than routine application of programming skills by one of ordinary skill in the art. Such an electronic controller may further be of the type having both ROM, RAM, a combination of non-volatile and volatile (modifiable) memory so that the software can be stored and yet allow storage and processing of dynamically produced data and/or signals.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method for determining a volumetric efficiency value of an internal combustion engine comprising the steps of:
determining an estimated mass air flow value of an air flow into the engine;
measuring an actual mass air flow value of the air flow;
determining a percentage error of the estimated mass air flow value as compared to the actual mass air flow value;
generating a correction value of the volumetric efficiency when the percentage error satisfies predetermined criteria indicative of a steady state air flow;
producing an updated value of the volumetric efficiency using a base value and the correction value.

2. The method of claim 1 wherein the step of determining an estimated mass air flow value includes the substep of:
evaluating a speed-density equation as a function of the base value of the volumetric efficiency.

3. The method of claim 1 wherein the step of determining when the percentage error satisfies predetermined criteria indicative of steady state air flow includes the substep of:
comparing the percentage error with a preselected numerical value.

4. The method of claim 1 wherein the step of generating a correction value of the volumetric efficiency includes the substep of:
integrating the percentage error to obtain the correction value.

5. The method of claim 1 further including the steps of:
determining an operating condition;
associating the correction value of the volumetric efficiency with the determined operating condition to form a data pair;
storing the data pair in an array.

6. The method of claim 5 wherein the data pair is a first one of a plurality of data pairs where the plurality of data pairs are configured to cover a corresponding plurality of operating conditions.
